(19) United States
(12) Patent Application Publication
(10) Pub. No.: US 2026/0143273 A1
(43) Pub. Date: May 21, 2026

(54) WIRELESS HEADSET

(71) Applicant: Merry Electronics(Shenzhen) Co., Ltd., ShenZhen (CN)

(72) Inventors: Hung-Uei Jou, Taichung (TW); Ko Min Wang, Taichung (TW); Chung-Yi Huang, Taichung (TW)

(73) Assignee: Merry Electronics(Shenzhen) Co., Ltd., ShenZhen (CN)

(21) Appl. No.: 19/000,744

(22) Filed: Dec. 24, 2024

(30) Foreign Application Priority Data
Nov. 19, 2024 (TW) 113144393

(51) Int. Cl. H04R 1/10

(52) U.S. Cl. CPC H04R 1/10; H04R 2420/07

(57) ABSTRACT

A wireless headset, including a headset body and a battery component. The headset body includes a housing, a conductive part and a first connecting component. The conductive part is located in the housing. The first connecting component is connected to the housing. The battery component is detachably connected to the headset body, and the battery component includes a second connecting component. In a first state, the battery component is assembled on the headset body, the first connecting component is fixed on the second connecting component, and the conductive part is electrically connected to the battery component. During the transition from the first state to a second state, an external force is used to drive the first connecting component to separate from the second connecting component, thereby causing the battery component to separate from the headset body.

### CROSS-REFERENCE TO RELATED APPLICATION

This application claims the priority benefit of Taiwan application serial no. 113144393, filed on Nov. 19, 2024. The entirety of the above-mentioned patent application is hereby incorporated by reference herein and made a part of this specification.

### BACKGROUND

### Technical Field

The disclosure relates to a headset, and in particular to a wireless headset.

### Description of Related Art

True wireless stereo (TWS) headsets do not require physical wires between the left and right earbuds, providing higher convenience in use. This prevents users from being restricted in their movements by traditional headset wires.

Furthermore, most TWS headsets require specific tools to remove the battery, making replacement inconvenient. During the replacement process, users may touch the battery, and sweat or moisture from their hands may cause damage to the battery.

### SUMMARY

A wireless headset allowing a battery cell to be replaced with high convenience is provided.

A wireless headset includes a headset body and a battery component. The headset body includes a housing, a conductive part, and a first connecting component. The conductive part is located in the housing. The first connecting component is connected to the housing. The battery component is detachably connected to the headset body and includes a second connecting component. In a first state, the battery component is assembled on the headset body, the first connecting component is fixed on the second connecting component, and the conductive part is electrically connected to the battery component. During a transition from the first state to a second state, an external force is used to drive the first connecting component to separate from the second connecting component, thereby causing the battery component to separate from the headset body. The housing has an opening. In the first state, the battery component is configured at the opening, with part of the battery component located in the opening and another part located outside the opening. The battery component includes a driving part. In the first state, the driving part is located outside the opening, with a length in an opening direction.

In an embodiment, the housing includes an inner surface, and the first connecting component is disposed on the inner surface and surrounds the opening.

In an embodiment, the battery component includes a battery cell and a sidewall surrounding the battery cell. The second connecting component is disposed on an outer surface of the sidewall. In the first state, the sidewall is covered by the housing.

In an embodiment, the battery cell has a first electrode and a second electrode, both oriented towards the same side. The second electrode surrounds the first electrode.

In an embodiment, the housing includes a front housing and a rear housing that are connected to each other. The front housing has a sound cavity outlet, and the rear housing has the opening.

In an embodiment, the headset body includes a partition disposed between the front housing and the rear housing to separate a first space and a second space. The first space communicates with the sound cavity outlet. The conductive part protrudes from the partition to extend into the second space. The second space is configured to accommodate the battery component. The first space and the second space are independently and separately disposed.

In an embodiment, the rear housing includes an ear stem part.

In an embodiment, one of the first connecting component and the second connecting component is a protrusion, and the other one of the first connecting component and the second connecting component is a sliding slot.

Based on the above, the battery component in the wireless headset may be detachably connected to the headset body without the need for additional tools, providing high convenience.

To make the features and advantages of the disclosure more comprehensible, several embodiments accompanied with drawings are described in detail as follows.

### BRIEF DESCRIPTION OF THE DRAWINGS

FIG. 1 is a perspective schematic view of a wireless headset according to an embodiment of the disclosure.

FIG. 2 is an exploded schematic view of the wireless headset shown in FIG. 1.

FIG. 3 is an exploded schematic view of the wireless headset shown in FIG. 2 from another perspective.

FIGS. 4A and 4B are perspective schematic views of the operation of the battery component of the wireless headset shown in FIG. 1.

FIG. 5 is a side schematic view of the wireless headset shown in FIG. 1.

### DESCRIPTION OF THE EMBODIMENTS

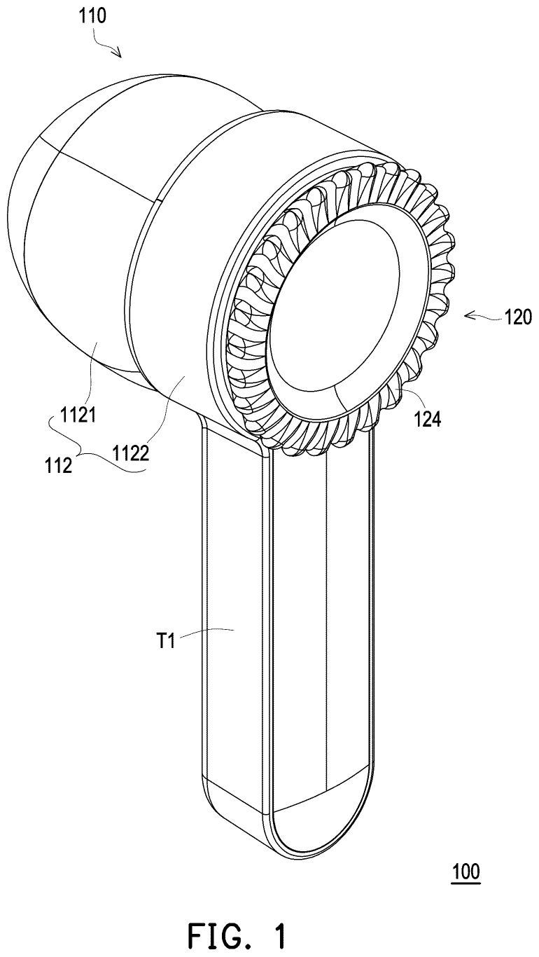

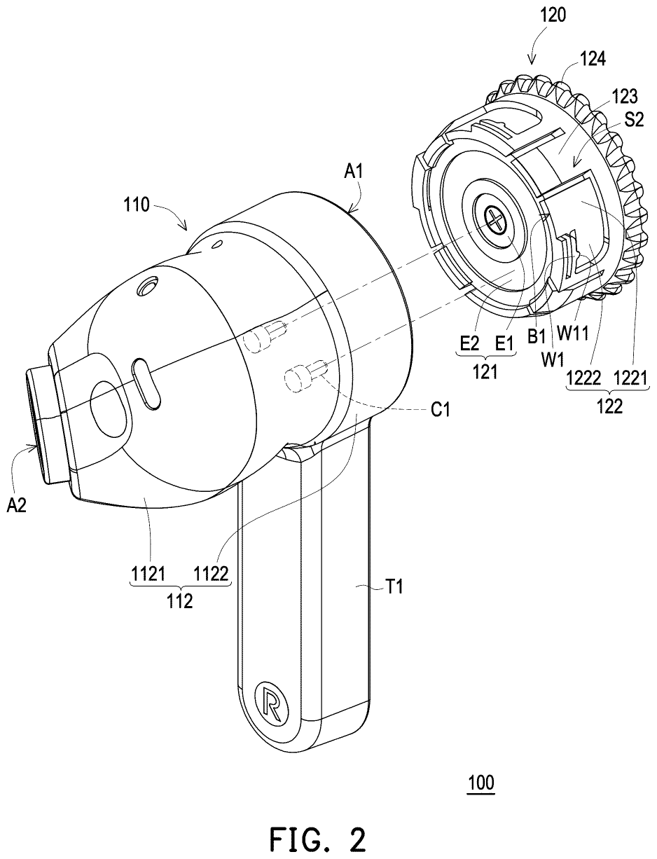

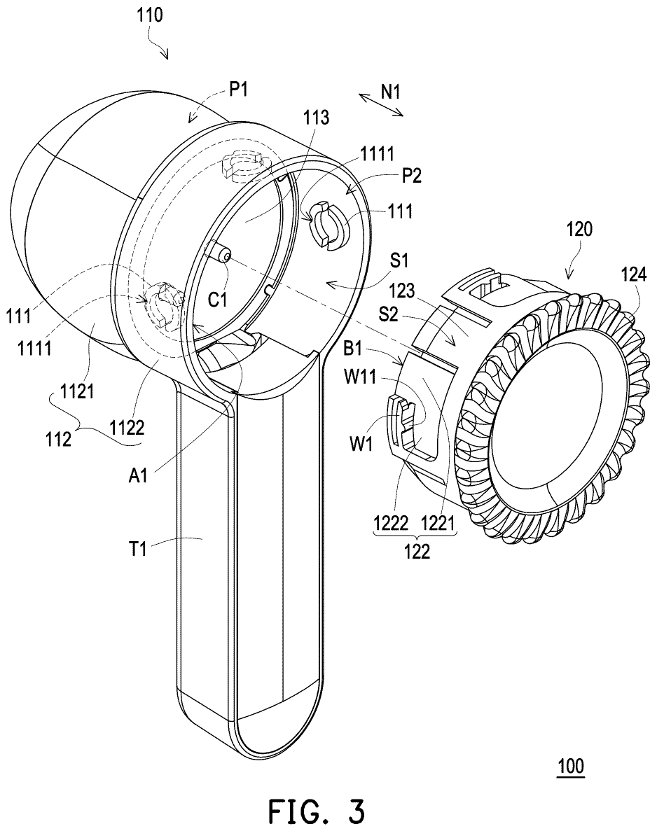

FIG. 1 is a perspective schematic view of a wireless headset according to an embodiment of the disclosure. FIG. 2 is an exploded schematic view of the wireless headset shown in FIG. 1. FIG. 3 is an exploded schematic view of the wireless headset shown in FIG. 2 from another perspective. It should be noted that in FIG. 2 and FIG. 3, only the components of the headset body that need to be explained are illustrated with dashed lines, while components such as the speaker are omitted to facilitate explanation.

Referring to FIGS. 1 to 3, a wireless headset 100 of this embodiment may be a true wireless stereo (TWS) headset. Specifically, two wireless headsets 100 may be used as a left earbud and a right earbud, respectively, for wireless connection with an electronic device (e.g., a smartphone or a tablet). However, the disclosure is not limited thereto.

In this embodiment, the wireless headset 100 includes a headset body 110 and a battery component 120. The battery component 120 is detachably connected to the headset body 110. Specifically, the headset body 110 includes a housing 112, a conductive part C1, and a first connecting component 111. The housing 112 has an opening A1. The conductive part C1 is located in the housing 112 and includes a first terminal and a second terminal for connecting positive and negative electrodes, respectively. The first connecting component 111 is connected to the housing 112. The battery component 120 includes a second connecting component 122 and a driving part 124.

In this embodiment, the housing 112 includes an inner surface S1. The first connecting component 111 is disposed on the inner surface S1 of the housing 112 and surrounds the opening A1. Here, the first connecting component 111 is a protrusion and has a first locking point 1111, but this is not limited thereto.

In this embodiment, the second connecting component 122 is disposed on an outer surface S2 of the battery component 120. Here, the second connecting component 122 is a sliding slot, but this is not limited thereto. For example, the second connecting component 122 has an entrance B1 facing away from the driving part 124 and includes a blocking wall W1 and a second locking point W11 located on the blocking wall W1.

In other embodiments, the first connecting component may be a sliding slot, and the second connecting component may be a protrusion. The disclosure is not limited thereto. In other embodiments, a snap-fit or thread connection may also be used between the headset body and the battery component for rotational assembly and disassembly. The disclosure is not limited thereto.

In this embodiment, the second connecting component 122 is an L-shaped sliding slot. When the first connecting component 111 enters the second connecting component 122 through the entrance B1, the first connecting component 111 is located in a first section 1221 of the second connecting component 122. By relatively rotating the battery component 120 with respect to the headset body 110, the first connecting component 111 may be positioned in a second section 1222 of the second connecting component 122 to achieve a locking effect. In this embodiment, the first section 1221 is parallel to an opening direction N1, and the second section 1222 is not parallel to the opening direction N1 due to the blocking wall W1, but the disclosure is not limited thereto.

In this embodiment, in addition to restricting the movement of the first connecting component 111 in the opening direction N1 through the blocking wall W1, the fixed effect may be enhanced by the mutual locking of the first locking point 1111 and the second locking point W11. In this embodiment, the first locking point 1111 is a recess, and the second locking point W11 is a protrusion, but the disclosure is not limited thereto.

In this embodiment, the driving part 124 of the battery component 120 is annular and has a textured surface to increase friction, facilitating operation by the user's fingers, but the disclosure is not limited thereto.

In an embodiment, when the wireless headset 100 is subjected to an impact, the stable connection between the battery component 120 and the headset body 110 ensures that a battery cell 121 does not easily fall out.

With the above configuration, the user may rotate the battery component 120 along a rotational direction R1 using the driving part 124 to lock or unlock the engagement between the first connecting component 111 and the second connecting component 122. In this way, the user may achieve an opening and closing action simply by relatively rotating the battery component 120 with respect to the headset body 110, without using tools, providing convenient operation and easy replacement of the battery component 120.

Specifically, referring to FIG. 2, in this embodiment, the battery component 120 includes a battery cell 121 and a sidewall 123 surrounding the battery cell 121. The battery cell 121 is fixed in the sidewall 123, the second connecting component 122 is disposed on the outer surface S2 of the sidewall 123, and the driving part 124 is connected to the sidewall 123. The battery cell 121 has a first electrode E1 and a second electrode E2 both oriented towards the same side. In other words, the first electrode E1 and the second electrode E2 are located on the same face. In this embodiment, the second electrode E2 surrounds the first electrode E1. For example, the first electrode E1 may be the positive electrode, and the second electrode E2 may be the negative electrode, but the disclosure is not limited thereto.

The benefit of this design is that the positive and negative contact positions of the battery cell 121 are annular rather than at a single point. Regardless of how the user rotates the battery component 120 to any angle, the conductive part C1 of the headset body 110 may correspondingly contact both the first electrode E1 and the second electrode E2 to establish electrical conduction with the battery cell 121.

Here, the conductive part C1 is a spring connector (POGO PIN), which may extend and retract along the opening direction N1 and may use both ends as contact points. However, the disclosure is not limited thereto.

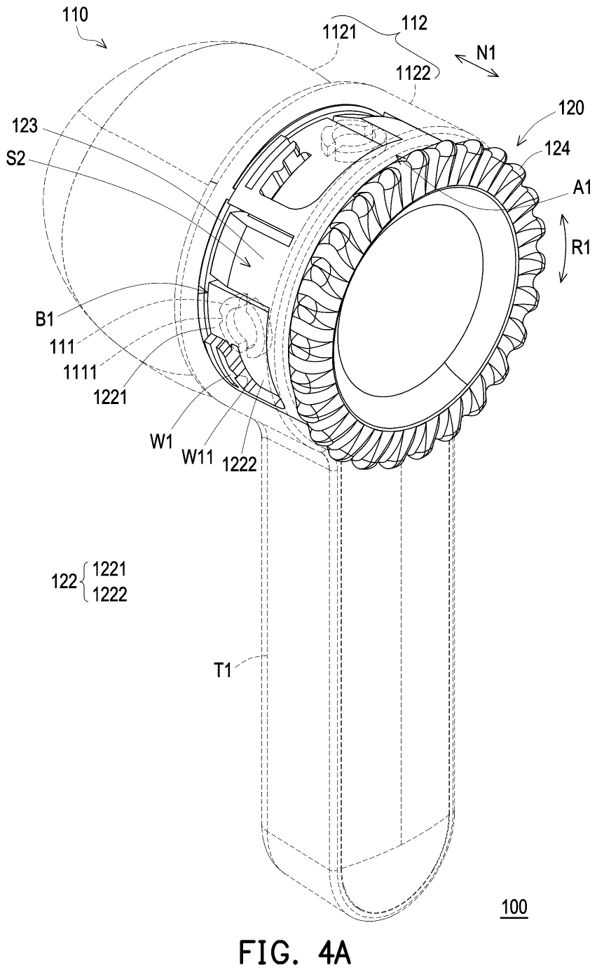

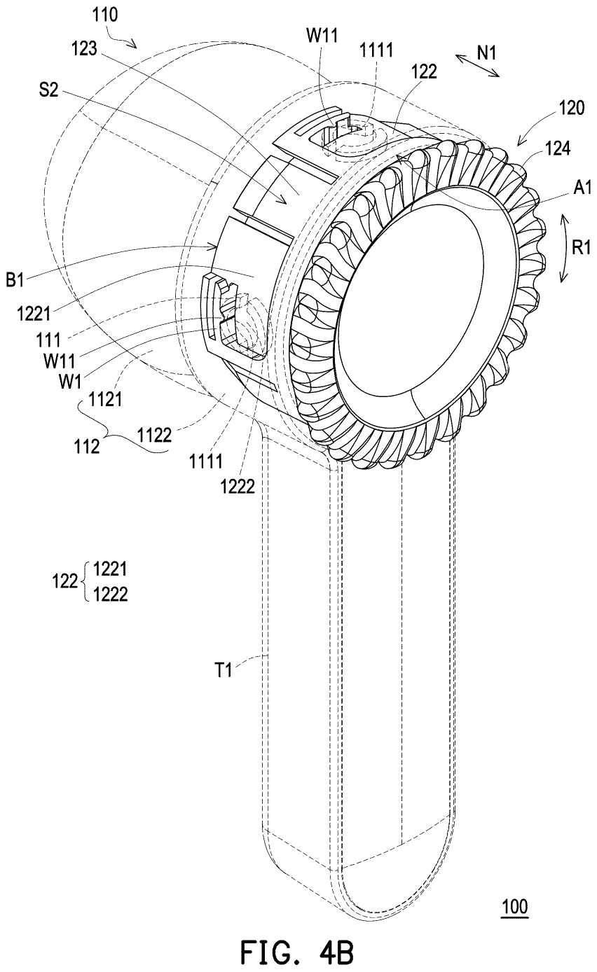

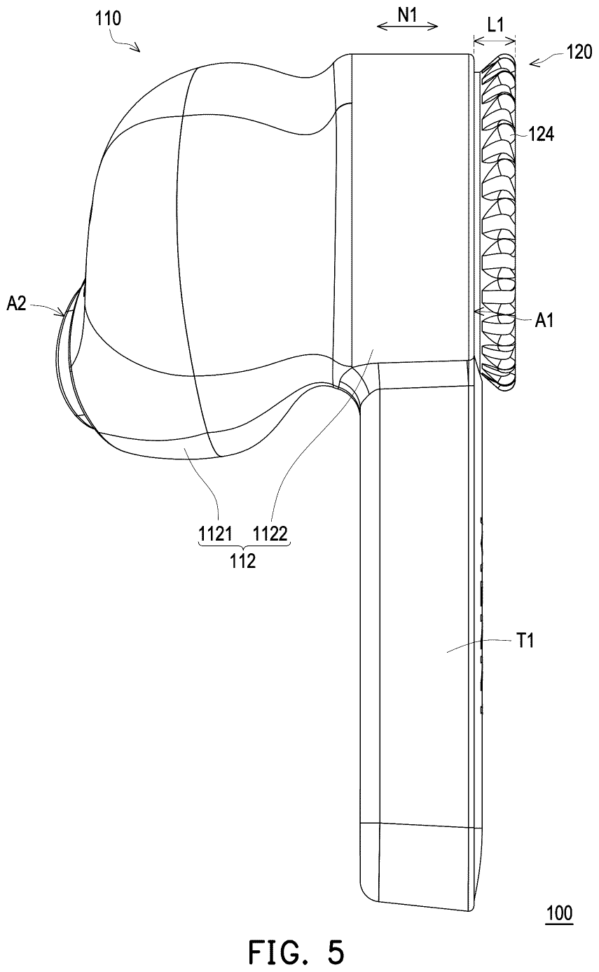

FIGS. 4A and 4B are perspective schematic views of the operation of the battery component of the wireless headset shown in FIG. 1. FIG. 5 is a side schematic view of the wireless headset shown in FIG. 1. It should be noted that in FIGS. 4A and 4B, the outline of the headset body and the first connecting component are illustrated with dashed lines to facilitate showing the connection relationship with the second connecting component of the battery component. Other internal components of the headset body are omitted for explanation purposes.

Referring first to FIGS. 3 and 4B, in the first state shown in FIG. 4B, the battery component 120 is assembled on the headset body 110 and corresponds to the opening A1. The first connecting component 111 is fixed on the second connecting component 122, the first locking point 1111 is fixed on the second locking point W11, and the conductive part C1 (FIG. 3) is electrically connected to the battery component 120.

During the transition from the first state shown in FIG. 4B to the second state shown in FIG. 3, an external force drives the first connecting component 111 to separate from the second connecting component 122, thereby causing the battery component 120 to separate from the headset body 110.

In this embodiment, in the first state shown in FIG. 4B, a part of the battery component 120 is located inside the opening A1, and another part of the battery component 120 is located outside the opening A1 to facilitate user operation for replacing the battery component 120. In other words, in the first state shown in FIG. 4B, the sidewall 123 of the battery component 120 is covered by the housing 112, and the driving part 124 of the battery component 120 is located outside the opening A1. Furthermore, referring to FIG. 5, the driving part 124 has a length L1 in the opening direction N1, where the length L1 is at least 2 millimeters to facilitate operation by the user's fingers, but the disclosure is not limited thereto.

Specifically, referring to FIGS. 3 and 4A, during the assembly process, the user inserts the battery component 120 into the opening A1 of the headset body 110, allowing the first connecting component 111 to enter the first section 1221 of the second connecting component 122 through the entrance B1. Next, the second connecting component 122 is rotated in the rotational direction R1 (e.g., clockwise) to move the first connecting component 111 into the second section 1222 of the second connecting component 122. The first locking point 1111 and the second locking point W11 engage with each other, completing the fixation and electrical connection, as shown in FIG. 4B.

Conversely, during the process of disassembling the battery component 120, the user simply rotates the second connecting component 122 in the rotational direction R1 (e.g., counterclockwise) to disengage the first locking point 1111 from the second locking point W11. The first connecting component 111 then moves from the second section 1222 to the first section 1221. Next, the user pulls the battery component 120 in a direction away from the headset body 110 to complete the disassembly. At this time, the user may insert another fully charged battery component into the headset body 110 to complete the replacement.

In an embodiment, when the wireless headset 100 is out of power or has a low battery level, the user may replace the entire battery component 120. The user's fingers will only touch the sidewall 123 and the driving part 124 of the battery component 120 and will not directly contact the battery cell 121, thereby preventing sweat from the fingers from corroding the battery cell 121. In an embodiment, an insulating material is further disposed between the battery cell 121 and the sidewall 123 to achieve better insulation.

In an embodiment, the battery component 120 may be additionally charged in a wireless headset charging case, facilitating replacement and use by the user.

Furthermore, referring to FIG. 2, in this embodiment, the housing 112 includes a front housing 1121 and a rear housing 1122 that are connected. The front housing 1121 has a sound cavity outlet A2, which is designed to be inserted into the user's ear canal. The rear housing 1122 includes the opening A1 and an ear stem portion T1.

Referring to FIG. 3, in this embodiment, the headset body 110 includes a partition 113 disposed between the front housing 1121 and the rear housing 1122 to separate a first space P1 and a second space P2. The first space P1 communicates with the sound cavity outlet A2 (FIG. 2). The conductive part C1 protrudes from the partition 113 to extend into the second space P2. The second space P2 is configured to accommodate the battery component 120. The first space P1 and the second space P2 are independently and separately disposed. Other electronic components of the wireless headset 100 may be arranged in the first space P1.

The advantage of this design is that, when the battery component 120 is removed, the second space P2 is the only exposed independent space. The user will not touch or see other electronic components of the headset body 110. In this way, when the user replaces the battery component 120, accidental contact or damage to other electronic components is prevented.

In summary, in the wireless headset of the disclosure, the battery component is detachably connected to the headset body. The user may rotate the battery component along the rotational direction using the driving part to lock or unlock the engagement between the first connecting component of the headset body and the second connecting component of the battery component. In this way, the user does not need tools and may achieve opening and closing actions simply by relatively rotating the battery component and the headset body, providing convenient operation and ease of battery component replacement. In an embodiment, the first electrode and the second electrode of the battery cell are located on the same face. Therefore, regardless of how the user rotates the battery component to any angle, the conductive part of the headset body may contact the first electrode and the second electrode to establish electrical conduction with the battery cell. Additionally, when the battery component is removed, the user will only see the conductive part inside the headset body and will not touch or see other electronic components of the headset body. In this way, when the user replaces the battery component, accidental contact with or damage to other electronic components is prevented.

Although the disclosure has been described with reference to the above embodiments, they are not intended to limit the disclosure. It will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

What is claimed is:

1. A wireless headset, comprising:
a headset body, comprising:
a housing;
a conductive part, located in the housing; and
a first connecting component, connected to the housing; and
a battery component, detachably connected to the headset body, the battery component comprising a second connecting component, wherein
in a first state, the battery component is assembled on the headset body, the first connecting component is fixed on the second connecting component, and the conductive part is electrically connected to the battery component, wherein
during a transition from the first state to a second state, an external force drives the first connecting component to separate from the second connecting component, thereby causing the battery component to separate from the headset body, wherein
the housing has an opening, and in the first state, the battery component is configured at the opening, a part of the battery component being located in the opening, and another part of the battery component being located outside the opening, wherein
the battery component comprises a driving part, and in the first state, the driving part is located outside the opening, the driving part having a length in an opening direction.

2. The wireless headset according to claim 1, wherein the housing comprises an inner surface, and the first connecting component is disposed on the inner surface and surrounds the opening.

3. The wireless headset according to claim 1, wherein the battery component comprises a battery cell and a sidewall surrounding the battery cell, the second connecting component is disposed on an outer surface of the sidewall, and in the first state, the sidewall is covered by the housing.

4. The wireless headset according to claim 3, wherein the battery cell has a first electrode and a second electrode both oriented towards a same side, and the second electrode surrounds the first electrode.

5. The wireless headset according to claim 1, wherein the housing comprises a front housing and a rear housing connected to each other, the front housing has a sound cavity outlet, and the rear housing has the opening.

6. The wireless headset according to claim 5, wherein the headset body comprises a partition, disposed between the front housing and the rear housing to separate a first space and a second space, wherein the first space communicates with the sound cavity outlet, the conductive part protrudes from the partition to extend into the second space, and the second space is configured to accommodate the battery component, the first space and the second space being independently and separately disposed.

7. The wireless headset according to claim 5, wherein the rear housing comprises an ear stem part.

8. The wireless headset according to claim 1, wherein one of the first connecting component and the second connecting component is a protrusion, and the other one of the first connecting component and the second connecting component is a sliding slot.
